(19) United States
(12) Patent Application Publication
(10) Pub. No.: US 2013/0181802 A1
(43) Pub. Date: Jul. 18, 2013

(54) SOFT MAGNETIC POWDER, GRANULATED POWDER, DUST CORE, ELECTROMAGNETIC COMPONENT, AND METHOD FOR PRODUCING DUST CORE

(71) Applicants: Asako Watanabe, Itami-shi (JP); Toru Maeda, Itami-shi (JP); Tomoyuki Ueno, Itami-shi (JP); Tomoyuki Ishimine, Itami-shi (JP)

(72) Inventors: Asako Watanabe, Itami-shi (JP); Toru Maeda, Itami-shi (JP); Tomoyuki Ueno, Itami-shi (JP); Tomoyuki Ishimine, Itami-shi (JP)

(73) Assignee: SUMITOMO ELECTRIC INDUSTRIES, LTD., Osaka-shi, Osaka (JP)

(21) Appl. No.: 13/824,106

(22) PCT Filed: Oct. 25, 2011
(86) PCT No.: PCT/JP2011/074570

§ 371 Date: Mar. 15, 2013

(30) Foreign Application Priority Data
Oct. 26, 2010 (JP) 2010-239561
Oct. 21, 2011 (JP) 2011-232195

(51) Int. Cl. H01F 1/20; H01F 27/255; H01F 1/24; H01F 41/02; H01F 1/28

(52) U.S. Cl. CPC H01F 1/20; H01F 41/0246; H01F 1/28; H01F 1/24; H01F 27/255
USPC 336/221; 419/10; 75/252; 252/62.51 R; 252/62.55; 252/62.53; 252/62.54

(57) ABSTRACT

Provided are a soft magnetic powder for obtaining a dust core having a low iron loss, the dust core, and a method for producing a dust core. The present invention relates to a soft magnetic powder including a plurality of soft magnetic particles, each having an insulating layer. The Vickers hardness HV0.1 of a material constituting the soft magnetic particles is 300 or more, and the insulating layer contains Si, O, and at least one of an alkali metal and Mg. As long as the soft magnetic powder has such features, a material having a high electric resistance, such as an iron-based alloy, can be used. The eddy current loss can be reduced, and it is possible to effectively obtain a dust core having a low iron loss.

### TECHNICAL FIELD

The present invention relates to a soft magnetic powder, a granulated powder obtained by granulation of the soft magnetic powder, a dust core using a granulated powder, an electromagnetic component using a dust core, and a method for producing a dust core.

### BACKGROUND ART

Conventionally, dust cores have been used as cores of electronic components, such as reactors, transformers, and choke coils. A dust core is produced by compacting a soft magnetic powder including a plurality of soft magnetic particles, each having an insulating layer, and then subjecting the resulting compact to heat treatment. As the soft magnetic powder, for example, PTL 1 discloses a soft magnetic material in which soft magnetic particles composed of pure iron are used from the viewpoint of magnetic permeability and flux density, and an insulating layer composed of a silicone resin is formed on the surface of each of the soft magnetic particles.

Properties required for a dust core include a low energy loss which is referred to as iron loss. The iron loss is generally expressed as a sum of a hysteresis loss and an eddy current loss, and in particular, becomes noticeable when used at high frequencies. The eddy current loss in the iron loss tends to decrease with increasing electric resistance of the material constituting soft magnetic particles. Consequently, it is expected that the eddy current loss can be reduced by adjusting the composition of soft magnetic particles and using an iron-based alloy having a high electric resistance.

### CITATION LIST

### Patent Literature

PTL 1: Japanese Unexamined Patent Application Publication No. 2010-001561

### SUMMARY OF INVENTION

### Technical Problem

An iron-based alloy is, however, generally harder than pure iron. In the case where an insulating layer composed of a resin material, such as a silicone resin, is formed on each of soft magnetic particles composed of an iron-based alloy, when pressure is applied to the soft magnetic powder, since the soft magnetic particles have a high hardness and are unlikely to be deformed, a large force is applied to each of the contact points between the soft magnetic particles, which may result in damage to the insulating layer. In order to reduce the iron loss, soft magnetic particles are required to be reliably insulated from one another. Therefore, if the insulating layer is damaged, the iron loss cannot be reduced. Accordingly, an insulating layer that can reliably insulate soft magnetic particles having a high hardness from one another has been desired.

Furthermore, from the standpoint of improving the working environment, reduction of wastes, ease of handling, and the like, it has been desired to avoid using a silicone resin as an insulating layer in the production of the dust core. The reason for this is that since the silicone resin is insoluble in water, an organic solvent is required when using the silicone resin.

The present invention has been achieved under the circumstances described above. It is an object of the present invention to provide a soft magnetic powder and a granulated powder for obtaining a dust core having a low iron loss.

It is another object of the present invention to provide a dust core having a low iron loss and an electromagnetic component using the dust core.

It is still another object of the present invention to provide a method for producing a dust core, by which it is possible to efficiently produce a dust core having a low iron loss.

### Solution to Problem

In the present invention, the above-mentioned objects are achieved by limiting the composition of an insulating layer which is most suitable for soft magnetic particles having a high hardness.

### [Soft Magnetic Powder]

The present invention relates to a soft magnetic powder including a plurality of soft magnetic particles, each having an insulating layer. The soft magnetic powder is characterized in that the Vickers hardness HV0.1 of a material constituting the soft magnetic particles is 300 or more, and the insulating layer contains Si, O, and at least one of an alkali metal and Mg.

According to the structure of the soft magnetic powder of the present invention, as long as the material constituting the soft magnetic particles has a Vickers hardness HV0.1 of 300 or more, a material having a high electric resistance, such as an iron-based alloy, can be used, and the eddy current loss can be reduced. Furthermore, since the insulating layer contains Si, O, and at least one of an alkali metal and Mg, it is possible to obtain an insulating layer which is hard and unlikely to be deformed. When pressure is applied to the soft magnetic powder, even if a large force is applied to each of the contact points between the soft magnetic particles having a high hardness, the insulating layer is unlikely to be damaged because it is also hard, and insulation between the soft magnetic particles can be sufficiently secured. As a result, in a dust core composed of the soft magnetic powder of the present invention, the dust core can have a low iron loss.

The insulating layer may further contain Al. The heat resistance of the insulating layer is expected to be improved by incorporating Al into the insulating layer. In this case, even if heat treatment is performed at high temperatures after compacting the soft magnetic powder, a good insulating property can be maintained, and it is expected to maintain a low iron loss.

Specific preferred examples the insulating layer include an insulating layer substantially composed of Si, O, and K and an insulating layer substantially composed of Si, Al, O, and Mg. These insulating layers have a good insulating property and can reduce the iron loss of the dust core. The term “substantially” means that the insulating layer may contain small amounts (20% by mass or less) of elements, such as incidental impurities.

According to an embodiment of the soft magnetic powder of the present invention, the soft magnetic particles may be composed of at least one of an Fe—Si—Al-based alloy, an Fe—Si-based alloy, an Fe—Al-based alloy, and an Fe-based amorphous alloy.

Among the soft magnetic particles having the composition described above, by using hard particles composed of a material having a Vickers hardness HV0.1 of 300 or more, the electric resistance can be increased, and the eddy current loss can be reduced.

According to an embodiment of the soft magnetic powder, the ratio of the mass of the insulating layer to the mass of the soft magnetic particles may be 0.1% to 1.0%.

The ratio of the mass of the insulating layer to the mass of the soft magnetic particles can be converted into the thickness of the insulating layer. In the case where the average particle size of the soft magnetic particles is 50 μm, when the ratio is 0.1%, the thickness of the insulating layer roughly corresponds to about 25 nm, and when the ratio is 1.0%, the thickness of the insulating layer roughly corresponds to about 250 nm. By setting the ratio to be 0.1% or more, insulation between the soft magnetic particles can be sufficiently secured. On the other hand, by setting the ratio to be 1.0% or less, when a dust core is produced using the soft magnetic powder, the amount of the soft magnetic particles in the dust core can be sufficiently secured.

### [Granulated Powder]

The present invention relates to a granulated powder to be formed into a compact by pressing, which is to be subjected to heat treatment to produce a dust core. The granulated powder includes the soft magnetic powder of the present invention described above and a molding resin which retains the shape of the compact after the pressing, characterized in that the soft magnetic powder and the molding resin are combined.

According to the structure of the granulated powder of the present invention, it is possible to obtain a compact with a high density in which the soft magnetic particles are insulated from one another by the insulating layer. By the addition of the molding resin, when the soft magnetic powder is formed into a compact, the shape of the compact can be reliably retained.

According to an embodiment of the granulated powder of the present invention, the molding resin may be an acrylic resin.

By using an acrylic resin as the molding resin, it is possible to obtain deformability during compaction and mechanical strength during retention of the shape.

### [Dust Core]

The present invention relates to a dust core including a plurality of soft magnetic particles and an insulating layer interposed between the soft magnetic particles. The dust core is characterized in that the Vickers hardness HV0.1 of a material constituting the soft magnetic particles is 300 or more, and the insulating layer contains Si, O, and at least one of an alkali metal and Mg.

According to the structure of the dust core of the present invention, as long as the material constituting the soft magnetic particles has a Vickers hardness HV0.1 of 300 or more, a material having a high electric resistance, such as an iron-based alloy, can be used, and the eddy current loss can be reduced. Since the insulating layer is also hard and unlikely to be deformed, even if a large force is applied to each of the contact points between the soft magnetic particles having a high hardness, the insulating layer is unlikely to be damaged, and insulation between the soft magnetic particles can be sufficiently secured. As a result, the dust core of the present invention can achieve a low iron loss. Specific preferred examples the insulating layer include an insulating layer substantially composed of Si, O, and K and an insulating layer substantially composed of Si, Al, O, and Mg.

According to an embodiment of the dust core, a dust core is produced by forming a compact by pressing and subjecting the compact to heat treatment, the compact including the soft magnetic powder of the present invention described above and a molding resin powder which retains the shape of the compact after the pressing.

Since the soft magnetic powder and the molding resin powder are included, the compact can be easily obtained.

According to another embodiment of the dust core, a dust core is produced by pressing the granulated powder of the present invention described above into a compact, and subjecting the compact to heat treatment.

The granulated powder can suppress aggregation of soft magnetic particles in the soft magnetic powder and improve the fluidity of the soft magnetic powder. Accordingly, the granulated powder is easy to handle, and it is possible to prevent uneven filling in a forming die. By pressing the granulated powder, it is possible to obtain a substantially uniform compact with a high density.

### [Method for Producing Dust Core]

According to the present invention, there is provided a method for producing a dust core in which soft magnetic powder including a plurality of soft magnetic particles, each having an insulating layer, is used, the method being characterized by including the following steps: (1) a preparation step of preparing soft magnetic particles composed of a material having a Vickers hardness HV0.1 of 300 or more, (2) a coating step of coating a surface of each of the soft magnetic particles with an insulating layer containing Si, O, and at least one of an alkali metal and Mg, (3) a mixing step of mixing the soft magnetic powder including a plurality of soft magnetic particles, each being coated with the insulating layer, and a molding resin powder to form a mixed powder, (4) a pressing step of pressing the mixed powder into a predetermined shape to form a compact, and (5) a heat treatment step of performing heat treatment on the compact to produce a fired body for forming a core.

According to this production method, it is possible to efficiently obtain a dust core of the present invention.

According to an embodiment of the method for producing a dust core of the present invention, a method includes, instead of the mixing step (3), a granulating step of forming a granulated powder, and the granulated is subjected to pressing and heat treatment. In the granulating step, the soft magnetic powder including a plurality of soft magnetic particles, each being coated with the insulating layer, and a molding resin are mixed and combined to form a granulated powder.

According to the method for producing a dust core in which a granulating step is performed, it is possible to obtain a substantially uniform dust core with a high density.

According to an embodiment of the method for producing a dust core of the present invention, in the coating step (2), the surface of each of the soft magnetic particles may be coated with the insulating layer by adding an aqueous solution of an alkali metal silicate or a hydrated magnesium silicate colloid solution to the soft magnetic particles while mixing the soft magnetic particles.

According to this method of coating with an insulating layer, the surface of each of the soft magnetic particles can be coated with an insulating layer containing Si, O, and at least one of an alkali metal and Mg. Furthermore, a silicate of an alkali metal is soluble in water, and a hydrated silicate of Mg, in the form of a colloid, is easily dispersed in water. Therefore, a uniform insulating layer can be easily formed on the surface of each of the soft magnetic particles by a simple wet process.

Furthermore, in the coating step, the solution to be added may contain Al. By using the solution containing Al, it is possible to form an insulating layer containing Al. For example, when an insulating layer composed of Si, O, and K is formed, an aqueous solution of potassium silicate is suitably used as the solution to be added. Furthermore, when an insulating layer composed of Si, Al, O, and Mg is formed, an Al-containing hydrated magnesium silicate colloid solution is suitably used as the solution to be added.

### [Electromagnetic Component]

An electromagnetic component of the present invention is characterized by including the dust core of the present invention and a coil formed by winding a winding wire around the outside of the dust core.

According to the structure of the electromagnetic component of the present invention, it is possible to provide an electromagnetic component which has a dust core having a low iron loss.

### Advantageous Effects of Invention

According to the soft magnetic powder or the granulated powder of the present invention, it is possible to obtain a dust core having a low iron loss.

According to the dust core of the present invention, a low iron loss can be achieved.

According to the method for producing a dust core of the present invention, it is possible to efficiently produce a dust core having a low iron loss.

According to the electromagnetic component of the present invention, it is possible to constitute an inductor including a dust core having a low iron loss.

### BRIEF DESCRIPTION OF DRAWINGS

FIG. 1 is a plan view of a choke coil using a dust core of the present invention.

### DESCRIPTION OF EMBODIMENTS

A soft magnetic powder, a granulated powder, a dust core, and an electromagnetic component according to the present invention will be described below in that order.

### [Soft Magnetic Powder]

<Structure>

A soft magnetic powder of the present invention includes a plurality of soft magnetic particles, each having an insulating layer.

(Soft Magnetic Particles)

The Vickers hardness HV0.1 of the material constituting the soft magnetic particles is 300 or more, and preferably 400 or more. Specifically, examples of such a material include Fe—Si—Al-based alloys, Fe—Si-based alloys, Fe—Al-based alloys, and Fe-based amorphous alloys. Regarding Fe—Si—Al-based alloys, an alloy containing 7% to 11% by mass of Si and 3% to 11% by mass of Al is suitable. Regarding Fe—Si-based alloys, an alloy containing 4.5% to 7% by mass of Si is suitable. The Vickers hardness HV0.1 is measured in accordance with JIS Z 2244 2009, and “HV0.1” means that the load of an indenter is 0.1 kgf (about 0.98 N) at the time of testing. Specific examples of the Vickers hardness HV0.1 of alloys are about 500 for Fe-9.5Si-5.5Al, about 300 for Fe-4.5Si, about 340 for Fe-5.0Si, and about 700 to 800 for Fe-based amorphous alloys. The iron-based alloys having such a hardness generally have high electric resistance and can reduce the eddy current loss. In particular, Fe—Si—Al-based alloys have a high hardness, a low iron loss, and good abrasion resistance. Preferably, the soft magnetic particles have a maximum particle size of 150 μm or less and an average particle size of 10 to 100 μm.

(Insulating Layer)

The insulating layer contains Si, O, and at least one of an alkali metal and Mg, and covers the outer peripheral surface of each of the soft magnetic particles, thereby securing insulation between the soft magnetic particles. The insulating layer of the present invention contains, as a main component, a silicate of an alkali metal or Mg, and therefore has a high hardness and is unlikely to be deformed. When pressure is applied to the soft magnetic powder, even if a large force is applied to each of the contact points between the soft magnetic particles having a high hardness, the insulating layer is unlikely to be damaged, and insulation between the soft magnetic particles can be sufficiently secured. Furthermore, a silicate of an alkali metal is soluble in water, and a hydrated silicate of Mg, in the form of a colloid, is easily dispersed in water. Therefore, a uniform insulating layer can be easily formed on the outer peripheral surface of each of the soft magnetic particles even by a simple wet process. Examples of the silicate of an alkali metal include potassium silicate (K₂SiO₃), sodium silicate (Na₂SiO₃), and lithium silicate (Li₂SiO₃). Among these, sodium silicate (also referred to as water glass or silicate of soda) has a low insulating property, when used alone, compared with a silicate, such as potassium silicate, and therefore desirably contains Al. The form of Al to be contained is not particularly limited. For example, Al may be contained in the form of aluminum silicate, aluminic acid; or the like. It is not always necessary for other silicates, such as potassium silicate, lithium silicate, or magnesium silicate, to contain Al. However, when Al is contained, the heat resistance of the insulating layer can be improved. By improving the heat resistance of the insulating layer, even when soft magnetic powder including a plurality of soft magnetic particles, each having the insulating layer, is subjected to heat treatment, a good insulating property can be maintained. Regarding the contents of the individual elements in the insulating layer, preferably, the Si content is 10% to 35% by mass, the 0 content is 20% to 70% by mass, and the total content of an alkali metal and Mg is 5% to 30% by mass. Furthermore, in the case where the insulating layer contains Al, preferably, the Al content is in a range of more than 0% to 20% by mass. Furthermore, the insulating layer may contain a small amount of an element other than Si, Al, O, an alkali metal, and Mg, and the content thereof is preferably 20% by mass or less. Examples of the element other than Si, Al, O, an alkali metal, and Mg include Fe and Ca.

The insulating layer is preferably formed such that the ratio of the mass of the insulating layer to the mass of the soft magnetic particles is 0.1% to 1.0%. The ratio of the mass of the insulating layer to the mass of the soft magnetic particles can be roughly converted into the thickness of the insulating layer. The conversion method can be obtained from the volume of the insulating layer and the surface area of the soft magnetic particles. The volume of the insulating layer can be obtained from the addition mass and specific gravity of the material constituting the insulating layer, and the surface area of the soft magnetic particles can be obtained from the average particle size thereof. In the case where the average particle size of the soft magnetic particles is 50 μm, when the ratio is 0.1%, the thickness of the insulating layer roughly corresponds to about 25 nm, and when the ratio is 1.0%, the thickness of the insulating layer roughly corresponds to about 250 nm. By setting the ratio to be 0.1% or more, insulation between the soft magnetic particles can be sufficiently secured. On the other hand, by setting the ratio to be 1.0% or less, when a dust core is produced using the soft magnetic powder, the amount of the soft magnetic particles in the dust core can be sufficiently secured.

<Production Method>

The soft magnetic powder of the present invention is obtained through a preparation step of preparing soft magnetic particles and a coating step of coating a surface of each of the soft magnetic particles with an insulating layer.

(Preparation Step)

In the preparation step, soft magnetic particles composed of the material described above are prepared. The soft magnetic particles are preferably produced by atomization, such as water atomization or gas atomization. Soft magnetic particles produced by water atomization have many irregularities on the surfaces of the particles, and therefore, because of interlocking of the irregularities, a compact having high strength is easily obtained. On the other hand, soft magnetic particles produced by gas atomization have a substantially spherical particle shape, and therefore, the number of irregularities that may break through the insulating coating film is small, which is preferable. Furthermore, the soft magnetic particles produced by atomization may be pulverized to a predetermined particle size before use. A natural oxide film may be formed on the surface of each of the soft magnetic particles.

(Coating Step)

In the coating step, a surface of each of the soft magnetic particles prepared in the preparation step is coated with an insulating layer containing Si, O, and at least one of an alkali metal and Mg. In the coating step, while stirring the soft magnetic particles using a mixer or the like or while tumbling the soft magnetic particles in a rotating container, an aqueous solution of an alkali metal silicate or a hydrated magnesium silicate colloid solution is added thereto and mixing is performed. The concentration of each of these solutions is set at 5% to 50% by mass, and the ratio of the mass of the solid content in the solution to the mass of the soft magnetic particles is set at 0.1% to 1.0%. Preferably, the number of revolutions of the mixer or the rotating container is set at 50 to 500 rpm, and mixing is performed at a temperature of 30° C. to 100° C. for 10 to 60 minutes. Furthermore, the solution is preferably sprayed using a sprayer. By performing spraying at the temperature described above, the sprayed solution is dried immediately after it adheres to the surface of each of the soft magnetic particles, and a dense insulating layer can be formed. Furthermore, since no resin is used in the insulating layer, the C content in the insulating layer is substantially zero. Unlike the case where coating is performed using a resin, it is not necessary to perform heat treatment at high temperatures to increase the hardness of the insulating layer, and it is also possible to perform the subsequent granulating step continuously after the coating step. In the soft magnetic powder including a plurality of soft magnetic particles, each coated with an insulating layer after mixing, in particular, using a mixer, some soft magnetic particles are bonded to one another through the insulating layer. Consequently, it is preferable to perform a “loosening” operation to separate the bonded particles. The loosening operation may be performed by lightly sieving the soft magnetic powder.

### [Granulated Powder]

<Structure>

The soft magnetic powder is further mixed with a molding resin to form a granulated powder. In the granulated powder, the soft magnetic powder and the molding resin are combined.

(Molding Resin)

The molding resin is a resin for retaining the shape of a compact when the soft magnetic powder is compressed into the compact. The molding resin is preferably a thermoplastic resin. Specific examples of the molding resin include acrylic resins, polyvinyl alcohol (PVA), polyvinyl butyral (PVB), silicone resins, and waxes, such as paraffin, fatty acid amides, and fatty acid esters. In particular, acrylic resins are preferable from the standpoint of achieving both deformability during compaction and mechanical strength during retention of the shape.

<Production Method>

(Granulating Step)

In the granulating step, the soft magnetic powder and the molding resin are mixed to form a granulated powder. In the granulating step, using a dry pan granulator or the like, the soft magnetic powder is tumbled while being heated, to which the molding resin diluted with water is added, and mixing is performed. The molding resin is added in the amount of 0.5% to 3.0% of the mass of the soft magnetic powder. By setting the addition ratio of the molding resin at 0.5% or more, the shape of the compact can be sufficiently retained. By setting the ratio at 3.0% or less, the amount of the resin in the mixture becomes appropriate, and the amount of the soft magnetic powder can be sufficiently secured in the compact or the dust core. Preferably, the number of revolutions of the granulator during tumbling is set at 50 to 500 rpm, and granulation is performed by mixing at a temperature of 30° C. to 100° C. for 10 to 120 minutes. The soft magnetic powder to which the molding resin has been added is dried by heating, and thus unit particles of granulated powder in which a plurality of soft magnetic particles are combined with the molding resin are formed. Furthermore, the molding resin is preferably sprayed using a sprayer. By performing spraying at the temperature described above, the sprayed molding resin is dried rapidly, and a uniform granulated powder can be formed. The same apparatus as that used in the coating step may be used as the granulator. In this case, coating and granulation can be continuously performed, which is preferable.

### [Dust Core]

<Structure>

A dust core of the present invention includes a plurality of soft magnetic particles and an insulating layer interposed between the soft magnetic particles. As described above, the Vickers hardness HV0.1 of the material constituting the soft magnetic particles is 300 or more. The insulating layer contains Si, O, and at least one of an alkali metal and Mg, and covers the outer peripheral surface of each of the soft magnetic particles, thereby securing insulation between the soft magnetic particles.

<Production Method>

The dust core of the present invention can be obtained by pressing the granulated powder into a compact, and performing heat treatment on the compact. That is, the dust core of the present invention is obtained through a pressing step of pressing the granulated powder into a predetermined shape to form a compact and a heat treatment step of performing heat treatment on the compact to produce a fired body for forming a core.

(Pressing Step)

In the pressing step, the granulated powder obtained in the granulating step is fed into a forming die, and the granulated powder inside the die is pressed into a compact. The shape of the compact may be selected depending on the shape of a core of an electromagnetic component. The pressure for pressing the granulated powder is preferably set at 500 to 1,500 MPa. By setting the pressure at 500 MPa or more, it is possible to obtain a compact with a high density. By setting the pressure at 1,500 MPa or less, the soft magnetic particles are not substantially deformed, and it is possible to suppress damage to the insulating layer.

(Heat Treatment Step)

In the heat treatment step, the compact obtained in the pressing step is subjected to heat treatment to produce a fired body for forming a core (dust core). The heating temperature in the heat treatment is preferably set at 400° C. to 1,000° C. Furthermore, the heating time is preferably set at 10 to 180 minutes. The soft magnetic powder constituting the compact before heat treatment has a large amount of strain introduced therein. By performing heat treatment on the compact under the conditions described above, the strain can be sufficiently removed. In addition, the atmosphere of the heat treatment may be appropriately selected depending on the soft magnetic particles, the insulating layer, other constituent materials, the use, and the like.

As the method for producing a dust core, it is preferable to produce a dust core using the granulated powder obtained in the granulating step as described above. The granulated powder can suppress aggregation of soft magnetic particles in the soft magnetic powder and improve the fluidity of the soft magnetic powder. Therefore, the granulated powder is easy to handle, and it is possible to prevent uneven filling in a forming die. Accordingly, by pressing the granulated powder, it is possible to obtain a substantially uniform compact or dust core with a high density. However, it is also possible to produce a dust core, without undergoing the granulating step, by performing a pressing step and a heat treatment step. For example, a soft magnetic powder and a molding resin powder which retains the shape of the compact after pressing are mixed by stirring with a mixer or the like to form a mixed powder, and the mixed powder is pressed to form a compact. In this case, in the pressing step, the pressure for pressing the mixed powder is preferably set at 500 to 1,500 MPa as in the case of pressing the granulated powder. Furthermore, in the heat treatment, as in the granulated powder, preferably, the heating temperature is set at 400° C. to 1,000° C., and the heating time is set at 10 to 180 minutes.

### [Electromagnetic Component]

An electromagnetic component of the present invention includes a magnetic core and a coil. The magnetic core is composed of the dust core described above. The magnetic core may be annular, rod-shaped, E-shaped, I-shaped, or the like. The coil is formed by winding a winding wire which includes a conductive wire and an insulating coating provided on the surface thereof. A winding wire having any of various cross-sectional shapes, such as a round or rectangular shape, can be used. For example, a round wire may be helically wound to constitute a cylindrical coil, and a rectangular wire may be helically wound edgewise to constitute a rectangular columnar coil.

The electromagnetic component may be formed by winding a winding wire around the outer periphery of the magnetic core, or by fitting an air core coil, which is helically wound in advance, on the outer periphery of the magnetic core.

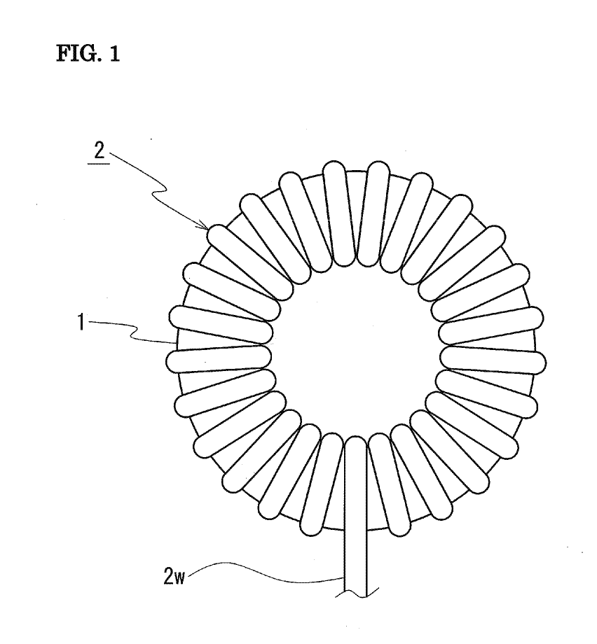

A specific example of the electromagnetic component is a choke coil which includes, as shown in FIG. 1, an annular magnetic core 1 and a coil 2 formed by winding a winding wire 2w around the outer periphery of the magnetic core 1. The annular magnetic core 1 is composed of a dust core of the present invention. Other examples include high-frequency choke coils, high-frequency tuning coils, bar antenna coils, power supply choke coils, power transformers, switching power transformers, reactors, and the like.

### Example 1

Under the conditions described below, soft magnetic powders were produced, and granulation, pressing, and heat treatment were performed to produce test pieces of dust cores. Magnetic properties were evaluated for the test pieces.

<Production of Samples>

First, soft magnetic particles are prepared, the soft magnetic particles being composed of an Fe-9.5 mass % Si-5.5 mass % Al alloy and obtained by gas atomization. The Vickers hardness HV0.1 of the alloy is about 500. The soft magnetic particles used have a maximum particle size of 106 μm and an average particle size of 60 μm.

Next, while stirring the soft magnetic particles, using a mixer, at a number of revolutions of 300 rpm, a potassium silicate aqueous solution is added thereto, and mixing is performed. The concentration of the aqueous solution was 30% by mass, and addition was performed such that the ratio of the mass of the solid content in the aqueous solution to the mass of the soft magnetic particles was 0.4%. The temperature during mixing was 40° C., and the mixing time was 20 minutes. An insulating layer substantially composed of Si, O, and K is formed on the surface of each of the soft magnetic particles after mixing. At this stage, the thickness of the insulating layer is about 110 nm. The contents of the individual elements in the insulating layer are as follows: Si: 24 mass %, O: 45 mass %, and K: 17 mass %. The oxygen content was measured by gas chromatograph mass spectrometry, and the contents of the other elements were measured by inductively coupled plasma emission spectrometry (ICP). Then, the resulting soft magnetic particles provided with the insulating layer are passed through a sieve to loosen the bonding between particles.

Subsequently, the soft magnetic particles coated with the insulating layer and a molding resin are mixed to form a granulated powder. An acrylic resin was used as the molding resin. Mixing was performed such that the amount of the acrylic resin was 1.0% by mass relative to the mass of the soft magnetic powder. Using a dry pan granulator, the soft magnetic powder was tumbled at a number of revolutions of 300 rpm while being heated, to which the acrylic resin diluted with water was added by spraying. The temperature during granulation was 40° C., and the granulating time was 60 minutes.

The resulting granulated powder is fed into a forming die, followed by compression to produce a compact. The compressing pressure during compacting is 980 MPa.

The resulting compact was subjected to heat treatment at 800° C.×1 hour in a nitrogen atmosphere to produce a dust core (Sample No. 1) shown in Table I.

A test piece composed of the resulting dust core is ring-shaped, having a rectangular cross section, with an outside diameter of 34 mm, an inside diameter of 20 mm, and a thickness of 5 mm.

By changing the constituent material of at least one of the soft magnetic particles and the insulating layer in the soft magnetic powder, dust cores (Sample Nos. 2 to 4) shown in Table I were produced as comparative products. In Sample No. 2, Fe-9.5 mass % Si-5.5 mass % Al was used for the soft magnetic particles, and a silicone resin was used for the insulating layer. An organic solvent is used as a solvent for the silicone resin. In the coating step of coating the surface of each of the soft magnetic particles with the insulating layer, the surface of each of the soft magnetic particles was coated with the silicone resin under the same coating conditions (addition amount of the silicone resin to the soft magnetic powder and temperature and time during mixing) as those in Sample No. 1, and then the resin was cured by performing heat treatment at 180° C.×1 hour. Then, the resulting soft magnetic particles provided with the silicone resin are passed through a sieve to loosen the bonding between particles. The subsequent granulation and pressing are performed as in Sample No. 1. The resulting compact was subjected to heat treatment at 720° C.×1 hour in a nitrogen atmosphere to produce a test piece of a dust core. The shape of the test piece is the same as that of Sample No. 1. In Sample No. 3, pure iron powder was used for the soft magnetic particles, and potassium silicate was used for the insulating layer. In the preparation step for the soft magnetic particles, pure iron powder obtained by water atomization with the same particle size as that of Sample No. 1 was prepared. The Vickers hardness HV0.1 of the soft magnetic particles of the pure iron powder is about 80. The coating step of coating the surface of the pure iron powder with an insulating layer is performed as in Sample No. 1. Then, the resulting soft magnetic powder was pressed under the same conditions as those in Sample No. 1, and heat treatment was performed at 420° C.×1 hour in a nitrogen atmosphere to produce a test piece of a dust core. The shape of the test piece is the same as that of Sample No. 1. In Sample No. 4, pure iron powder was used for the soft magnetic particles, and a silicone resin was used for the insulating layer. As the pure iron powder, the same pure iron powder as that of Sample No. 3 was prepared, and the surface of the pure iron powder was coated with the silicone resin in the coating step in the same manner as that of Sample No. 2. The subsequent production of a dust core through pressing and heat treatment and the shape of a test piece are the same as those of Sample No. 3.

Furthermore, soft magnetic particles were prepared, the soft magnetic particles being composed of an Fe-4.0 to 5.0 mass % Si alloy and obtained by gas atomization. The particle size of the soft magnetic particles was the same as that of Sample No. 1. The surface of each of the soft magnetic particles was coated with an insulating layer composed of potassium silicate. The coating conditions of the insulating layer were the same as those in Sample No. 1, and production of dust cores through granulation, pressing, and heat treatment was performed as in Sample No. 1. Thereby, dust cores (Sample Nos. 5 to 7) shown in Table I were obtained. The Vickers hardness HV0.1 of each of the alloys is also shown in Table I. The shape of each of the test pieces of the dust cores is the same as that of Sample No. 1. Furthermore, the surface of each of the same soft magnetic particles as those in Sample Nos. 5 to 7 was coated with an insulating layer composed of a silicone resin. The coating conditions of the insulating layer were the same as those in Sample No. 2. Granulation and pressing were performed as in Sample No. 1, and production of dust cores through heat treatment was performed as in Sample No. 2. Thereby, dust cores (Sample Nos. 8 to 10) shown in Table I were obtained. The shape of each of the test pieces of the dust cores is the same as that of Sample No. 1.

TABLE I

| | Raw | Vickers hardness | |
|---|---|---|---|
| Sample No. | material powder | HV0.1 | Insulating material |
| 1 | Fe—9.5Si—5.5Al | 500 | Potassium silicate |
| 2 | Fe—9.5Si—5.5Al | 500 | Silicone resin |
| 3 | Fe | 80 | Potassium silicate |
| 4 | Fe | 80 | Silicone resin |
| 5 | Fe—4.0Si | 260 | Potassium silicate |
| 6 | Fe—4.5Si | 300 | Potassium silicate |
| 7 | Fe—5.0Si | 340 | Potassium silicate |
| 8 | Fe—4.0Si | 260 | Silicone resin |
| 9 | Fe—4.5Si | 300 | Silicone resin |
| 10 | Fe—5.0Si | 340 | Silicone resin |

<Evaluation>

Magnetic properties were measured for each of the samples produced as described above, and the dust cores were evaluated. The evaluation results are shown in Table II.

A winding wire was wound around each of the ring-shaped test pieces to obtain a measurement object in order to measure the magnetic properties of the test piece. Using a B-H/μ analyzer SY8258 manufactured by Iwatsu Test Instruments Corporation, the iron loss W1/100 k (kW/m³) at an excitation flux density Bm of 1 kG (=0.1 T) and a measurement frequency of 100 kHz and the AC initial magnetic permeability μ iac were measured for the measurement object. The temperature at the time of measurement was room temperature (25° C. in this case). Furthermore, using an electromagnet, a magnetic field of 10 kG (1 T) was applied to the test piece, and the saturation flux density Bs (T) of the test piece was measured with a DC-BH tracer. The temperature at the time of measurement was room temperature (25° C. in this case).

Furthermore, the safety level of the working environment was evaluated. The safety level of the working environment was determined depending on whether or not an organic solvent was used in the production process of the dust core. The case where an organic solvent was used was evaluated to be poor (x), and the case where an organic solvent was not used was evaluated to be good (◯). The results thereof are shown in Table II.

TABLE II

| | W1/100k | | BS | Safety level of |
|---|---|---|---|---|
| Sample No. | (kW/m³) | μ iac | (T) | environment |
| 1 | 553 | 54 | 0.8 | ◯ |
| 2 | 1747 | 62 | 0.8 | X |
| 3 | 6643 | 108 | 2.0 | ◯ |
| 4 | 3454 | 130 | 2.0 | X |
| 5 | 4210 | 101 | 1.8 | ◯ |
| 6 | 2496 | 95 | 1.7 | ◯ |
| 7 | 1741 | 79 | 1.6 | ◯ |
| 8 | 3076 | 123 | 1.8 | X |
| 9 | 2920 | 107 | 1.7 | X |
| 10 | 3016 | 90 | 1.6 | X |

<Evaluation Results>

As is obvious from the results of Table II, in the case where the Vickers hardness HV0.1 of the material constituting the soft magnetic particles is 300 or more, and an alloy material having the same composition is used as the material constituting the soft magnetic particles, in the samples whose insulating layer is composed of potassium silicate, the iron loss W1/100 k is kept low.

When an alloy having a high electrical resistance is used as the material constituting the soft magnetic particles, the eddy current loss (iron loss) can be reduced. However, in the case where soft magnetic particles having a high hardness are coated with an insulating layer composed of a silicone resin as in Sample No. 2, the iron loss W1/100 k is increased compared with the case where soft magnetic particles having a high hardness are coated with an insulating layer composed of potassium silicate as in Sample No. 1. Since soft magnetic particles having a high hardness are unlikely to be deformed, a large force is applied to each of the contact points between the particles. Consequently, it is believed that when a material that is soft and likely to be deformed, such as a silicone resin, is used for the insulating layer, the insulating layer is damaged at the contact points, and the particles cannot be insulated from one another, resulting in an increase in the iron loss. On the other hand, it is believed that when a material that is hard and unlikely to be deformed, such as potassium silicate, is used for the insulating layer, even if a large force is applied to the contact points, the insulating layer is not damaged because it is also hard, and insulation between the particles can be sufficiently secured, resulting in a reduction in the iron loss.

However, in the case where soft magnetic particles composed of pure iron powder is coated with an insulating layer composed of potassium silicate, as in Sample No. 3, the iron loss W1/100 k is increased compared with the case where soft magnetic particles composed of pure iron powder is coated with an insulating layer composed of a silicone resin as in Sample No. 4. The reason for this is believe to be that since the soft magnetic particles composed of pure iron powder are soft and likely to be deformed and the insulating layer is hard and unlikely to be deformed, even if the particles are deformed, the insulating layer does not follow the deformation the particles, therefore, the insulating layer is separated from the surface of each of the particles, and insulation between the particles cannot be achieved, resulting in an increase in the iron loss. On the other hand, it is believed that when a silicone resin is used for coating soft magnetic particles that are soft and likely to be deformed, since the insulating layer follows the deformation of the particles, the insulating layer is not likely to be broken.

In Sample Nos. 5 to 10, by adjusting the composition of the soft magnetic particles and by coating a hard material having a Vickers hardness HV0.1 of 300 or more with an insulating layer composed of a material that is hard and unlikely to be deformed, such as potassium silicate, the iron loss can be reduced. In Sample Nos. 6 and 7, although the iron loss is high compared with Sample No. 1, the AC initial magnetic permeability and the saturation flux density can be increased.

### Example 2

Next, a test piece of a dust core was produced by performing pressing and heat treatment on a soft magnetic powder, without performing granulation, and magnetic properties were evaluated for the test piece.

An Fe—Si—Al alloy powder, which is the same as that in Sample No. 1, is prepared and coated with an insulating layer composed of potassium silicate. The coating conditions were the same as those in Sample No. 1. Next, the resulting soft magnetic powder including a plurality of soft magnetic particles, each coated with the coating layer, and a molding resin powder are mixed using a mixer. A PVA powder was used as the molding resin powder. The PVA powder was added in the amount of 2.0% of the mass of the soft magnetic particles. The number of revolutions of the mixer during mixing was set at 300 rpm, the temperature was set at room temperature (25° C. in this case), and the mixing time was set at 20 minutes. Then, pressing and heat treatment were performed on the resulting mixed powder under the same conditions as those for Sample No. 1. Thereby, a test piece of a dust core (Sample No. 11) was obtained. The shape of the test piece was the same as that of Sample No. 1.

Magnetic properties and the safety level of the environment were evaluated for the resulting test piece as in Sample No. 1. The results thereof are shown in Table III.

TABLE III

| | W1/100k | | Safety level of | BS |
|---|---|---|---|---|
| Sample No. | (kW/m³) | μ iac | environment | (T) |
| 11 | 560 | 48 | ◯ | 0.8 |

<Evaluation Results>

As is obvious from the results of Table III, the iron loss W1/100 k is kept low as in Sample No. 1 in which the test piece was produced through granulation.

### Example 3

First, soft magnetic particles pulverized to a predetermined particle size are prepared, the soft magnetic particles being composed of an Fe-9.5 mass % Si-5.5 mass % Al alloy and obtained by water atomization. The Vickers hardness HV0.1 of the alloy is about 500. The soft magnetic particles used have a maximum particle size of 150 μm and an average particle size of 45 μm.

Next, while heating and tumbling the soft magnetic particles at a number of revolutions of 300 rpm using a dry pan granulator, an Al-containing hydrated magnesium silicate colloid solution is added thereto by spraying, and mixing is performed. The concentration of the colloid solution was 12% by mass, and the colloid solution was added such that the mass of the solid content of the solution was 0.4% relative to the mass of the soft magnetic particles. The temperature during mixing was 40° C., and the mixing time was 40 minutes. An insulating layer substantially composed of Si, Al, O, and Mg is formed on the surface of each of the soft magnetic particles after mixing. At this stage, the thickness of the insulating layer is about 110 nm. The contents of the individual elements in the insulating layer are as follows: Si: 19 mass %, O: 45 mass %, Al: 8 mass %, and Mg: 10 mass %. The contents of the individual elements were measured as in Example 1.

Subsequently, while tumbling the soft magnetic particles coated with the insulating layer using a dry pan granulator, a molding resin diluted with water is added thereto by spraying to produce a granulated powder. An acrylic resin was used as the molding resin. The acrylic resin was used in the amount of 1.0% by mass relative to the mass of the soft magnetic powder. The number of revolutions and the temperature of the dry pan granulator were set at 300 rpm and 40° C., respectively, as in the coating step of the insulating layer. The granulation time was set to be 60 minutes.

Pressing was performed on the resulting granulated powder under the same conditions as those for Sample No. 1 of Example 1, and heat treatment was performed at 700° C.×1 hour in an air atmosphere to produce a test piece of a dust core (Sample No. 12). The shape of the test piece was the same as that of Sample No. 1 in Example 1.

A test piece of a dust core (Sample No. 13) was produced as a comparative product using the same soft magnetic particles as those in Sample No. 12 and using a silicone resin for the insulating layer. The surface of each of the soft magnetic particles was coated with the silicone resin in the coating step in the same manner as that for No. 2 of Example 1. Subsequently, pressing and heat treatment were performed to produce a dust core as in No. 2 of Example 1. The shape of the test piece is the same as that of Sample No. 12.

TABLE IV

| | W1/100k | | Safety level of | BS |
|---|---|---|---|---|
| Sample No. | (kW/m³) | μ iac | environment | (T) |
| 12 | 719 | 70 | ◯ | 0.8 |
| 13 | 1892 | 81 | X | 0.8 |

<Evaluation Results>

As is obvious from the results of Table IV, in Sample No. 12 in which the soft magnetic particles are coated with the insulating layer composed of Al-containing magnesium silicate, the iron loss W1/100 k is kept low compared with Sample No. 13 in which the soft magnetic particles are coated with the insulating layer composed of a silicone resin.

### Example 4

Soft magnetic particles composed of the Fe—Si—Al alloy used in Sample No. 1 are prepared and coated with an insulating layer composed of Al-containing potassium silicate. In this example, an Al-containing potassium silicate aqueous solution was used as a solution to be added in the coating step. The concentration of the aqueous solution was 30% by mass, and addition was performed such that the ratio of the mass of the solid content in the solution to the mass of the soft magnetic particles was 0.4%. Other than this, the coating conditions were the same as those for Sample No. 1. An insulating layer substantially composed of Si, Al, O, and K is formed on the surface of each of the resulting soft magnetic particles. At this stage, the thickness of the insulating layer is about 110 nm. The contents of the individual elements in the insulating layer are as follows: Si: 24 mass %, Al: 3 mass %, O: 43 mass %, and K: 15 mass %. The contents of the individual elements were measured as in Example 1. Then, granulation and pressing were performed under the same conditions as those in Sample No. 1. The resulting compact was subjected to heat treatment at 800° C.×1 hour in a nitrogen atmosphere to produce a test piece of a dust core (Sample No. 14). The shape of the test piece was the same as that of Sample No. 1.

Magnetic properties and the safety level of the environment were evaluated for the resulting test piece as in Sample No. 1. The results thereof are shown in Table V.

TABLE V

| | W1/100k | | Safety level of | BS |
|---|---|---|---|---|
| Sample No. | (kW/m³) | μ iac | environment | (T) |
| 14 | 518 | 44 | ◯ | 0.8 |

As is obvious from the results of Table V, in Sample No. 14 in which the soft magnetic particles are coated with the insulating layer composed of Al-containing potassium silicate, the iron loss W1/100 k is kept low compared with Sample No. 1.

As described above, according to the soft magnetic powder of the present invention, it was possible to obtain a dust core having a low iron loss by using an insulating layer capable of reliably insulating soft magnetic particles having a high hardness from one another.

In the method for producing a dust core according to the present invention, since a resin material, such as a silicone resin, is not used for the insulating layer, heat treatment of the resin is not required, and the number of production steps can be decreased. Thus, the method is efficient. Since a silicone resin is not used, an organic solvent is not required. Thus, the method has a good safety level of the environment.

It is to be understood that the present invention is not limited to the examples described above. Various modifications are possible within a range not departing from the gist of the present invention.

### INDUSTRIAL APPLICABILITY

The soft magnetic powder, the granulated powder, and the method for producing a dust core according to the present invention can be suitably used for obtaining dust cores used for various inductors. Furthermore, electromagnetic components of the present invention can be suitably used for high-frequency choke coils, high-frequency tuning coils, bar antenna coils, power supply choke coils, power transformers, switching power transformers, reactors, and the like.

### REFERENCE SIGNS LIST

1 magnetic core
2 coil
2w winding wire

1.-17. (canceled)

18. A soft magnetic powder comprising a plurality of soft magnetic particles, each having an insulating layer, the soft magnetic powder being characterized in that the Vickers hardness HV0.1 of a material constituting the soft magnetic particles is 300 or more, and the insulating layer contains Si, O, and at least one of an alkali metal and Mg.

19. The soft magnetic powder according to claim 18, characterized in that the insulating layer further contains Al.

20. The soft magnetic powder according to claim 18, characterized in that the insulating layer is substantially composed of Si, O, and K.

21. The soft magnetic powder according to claim 19, characterized in that the insulating layer is substantially composed of Si, Al, O, and Mg.

22. The soft magnetic powder according to claim 18, characterized in that the soft magnetic particles are composed of at least one of an Fe—Si—Al-based alloy, an Fe—Si-based alloy, an Fe—Al-based alloy, and an Fe-based amorphous alloy.

23. A granulated powder to be formed into a compact by pressing, which is to be subjected to heat treatment to produce a dust core, the granulated powder comprising:
the soft magnetic powder according to claim 18; and
a molding resin which retains the shape of the compact after the pressing,
characterized in that the soft magnetic powder and the molding resin are combined.

24. The granulated powder according to claim 23, characterized in that the molding resin is an acrylic resin.

25. A dust core comprising a plurality of soft magnetic particles and an insulating layer interposed between the soft magnetic particles, characterized in that the Vickers hardness HV0.1 of a material constituting the soft magnetic particles is 300 or more, and the insulating layer contains Si, O, and at least one of an alkali metal and Mg.

26. The dust core according to claim 25, characterized in that the insulating layer is substantially composed of Si, O, and K.

27. The dust core according to claim 25, characterized in that the insulating layer is substantially composed of Si, Al, O, and Mg.

28. A dust core characterized by being produced by pressing the granulated powder according to claim 23, into a compact, and subjecting the compact to heat treatment.

29. A method for producing a dust core in which soft magnetic powder including a plurality of soft magnetic particles, each having an insulating layer, is used, the method being characterized by comprising:
a preparation step of preparing soft magnetic particles composed of a material having a Vickers hardness HV0.1 of 300 or more;
a coating step of coating a surface of each of the soft magnetic particles with an insulating layer containing Si, O, and at least one of an alkali metal and Mg;
a mixing step of mixing the soft magnetic powder including a plurality of soft magnetic particles, each being coated with the insulating layer, and a molding resin powder to form a mixed powder;
a pressing step of pressing the mixed powder into a predetermined shape to form a compact; and
a heat treatment step of performing heat treatment on the compact to produce a fired body for forming a core.

30. A method for producing a dust core in which soft magnetic powder including a plurality of soft magnetic particles, each having an insulating layer, is used, the method being characterized by comprising:
a preparation step of preparing soft magnetic particles composed of a material having a Vickers hardness HV0.1 of 300 or more;
a coating step of coating a surface of each of the soft magnetic particles with an insulating layer containing Si, O, and at least one of an alkali metal and Mg;
a granulating step of forming a granulated powder by mixing and combining the soft magnetic powder including a plurality of soft magnetic particles, each being coated with the insulating layer, and a molding resin;
a pressing step of pressing the granulated powder into a predetermined shape to form a compact; and
a heat treatment step of performing heat treatment on the compact to produce a fired body for forming a core.

31. The method for producing a dust core according to claim 29, characterized in that, in the coating step, the surface of each of the soft magnetic particles is coated with the insulating layer by adding an aqueous solution of an alkali metal silicate or a hydrated magnesium silicate colloid solution to the soft magnetic particles while mixing the soft magnetic particles.

32. The method for producing a dust core according to claim 31, characterized in that the solution to be added in the coating step is an aqueous solution of potassium silicate.

33. The method for producing a dust core according to claim 31, characterized in that the solution to be added in the coating step is an Al-containing hydrated magnesium silicate colloid solution.

34. An electromagnetic component characterized by comprising the dust core according to claim 25, and a coil formed by winding a winding wire around the outside of the dust core.
